(19) United States
(12) Patent Application Publication
(10) Pub. No.: US 2005/0083823 A1
(43) Pub. Date: Apr. 21, 2005

(54) Emitted-light checking apparatus for optical pickup

(75) Inventors: Yasuhisa Miyata, Saitama-ken (JP); Nobuo Tosa, Saitama-ken (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignees: Pioneer Corporation; Pioneer FA Corporation

(21) Appl. No.: 10/964,680

(22) Filed: Oct. 15, 2004

(30) Foreign Application Priority Data
Oct. 16, 2003 (JP) 2003-355797

(51) Int. Cl. G11B 7/00

(52) U.S. Cl. 369/112.01; 369/44.23

(57) ABSTRACT

An emitted-light checking apparatus receives laser beam which has been emitted from a laser diode of an optical pickup subject to check. The laser beam travels through a cylindrical lens provided for producing astigmatism, and then enters a light receiving device that includes an optoelectronic integrated circuit having a receiving surface split into four receiving areas arranged in the upper-right, upper-left, bottom-right and bottom-let positions.

### BACKGROUND OF THE INVENTION

1. Field of the Invention

This invention relates to an apparatus of checking parallelism and inclination of an optical axis of emitted light in an optical pickup.

The present application claims priority from Japanese Application No. 2003-355797, the disclosure of which is incorporated herein by reference.

2. Description of the Related Art

FIG. 1 is a perspective view schematically illustrating a typical structure of an optical pickup used in a DVD player or DVD recorder.

In FIG. 1, an optical pickup P is constituted of: a DVD (Digital Versatile Disc) laser diode LD1 and a CD (Compact Disc) laser diode LD2 for emitting beams at different wavelengths from each other; collimator lenses 1A and 1B for respectively adjusting the parallelism (focus) of beams emitted from the DVD laser diode LD1 and the CD laser diode LD2; half mirrors 2 and 3 and a mirror 4 for guiding each of the beams b1 and b2, emitted from the DVD laser diode LD1 and CD laser diode LD2, along a predetermined path; an objective lens 5 undergoing focus control by an actuator to irradiate a disc with the beam; a multi lens 6 for receiving a beam b3 reflecting off a disc D and then passing through the objective lens 5, mirror 4 and half mirror 3; and a light receiving device 7, such as a photo-detector or an OEIC (Opto-Electronic Integrated Circuit), for receiving the reflected beam b3 focused by the multi lens 6 to read the information.

When the optical pickup P such structured is used in readable DVD players or CD players in the conventional manner, a fundamental requirement is that the parallelism adjustment and optical-axis angle adjustment to the reflected beam b3 are terminated before the reflected beam 3b enters the light receiving device 7. Therefore, prior to the process for mounting the optical pickup P on a player or the like, the optical pickup P is adjusted in the manufacturing process for the optical pickup P, with emphasis on an attitude adjustment to the actuator actuating the objective lens 5 by use of a beam spot adjuster (an optical-axis adjustment in the traveling path of light before reflection off of a disc), and on a focus adjustment to the multi lens 6 and a positional adjustment to the light receiving device 7 by use of an optical-axis adjuster (an optical-axis adjustment in the light receiving portion).

Such a conventional optical-axis adjusting apparatus is described in Japanese unexamined patent publication No. 2002-133708, for example.

Recently, various types of recordable apparatuses using an optical pickup, such as a DVD recorder and a CD recorder, have became commonplace. The optical pickup P used in such recordable apparatuses requires precise parallelism adjustment and optical-axis angle adjustment to the emitted beams b1 and b2 from the DVD laser diode LD1 and the CD laser diode LD2 in order to improve power efficiency during recording operation.

In a conventional parallelism adjustment to the emitted beams b1 and b2 (hereinafter collectively referred to as “emitted beam b”) from the DVD laser diode LD1 and the CD laser diode LD2 (hereinafter collectively referred to as “laser diode LD”), the emitted beam b is sent over a long distance and then a shape of the beam is checked visually or by means of a method of sending the emitted beam into a CCD for image processing or the like. Based on the evaluation result, as shown in FIG. 2, fine adjustment is made to the position of the collimator lens 1A or 1B (hereinafter collectively referred to as “collimator lens 1”) in the axial direction (in the z direction).

In a conventional optical-axis angle adjustment to the emitted beam b from the laser diode LD, an emission angle from the laser diode LD and the inclination of the optic axis are checked visually by the use of an auto-collimator, or alternatively, by means of image processing using the CCD. Then, based on the evaluation result, as shown in FIG. 3, fine adjustment is made to the position and/or the angel of the laser diode LD in two directions at right angles to the optical axis of the emitted beam b (i.e. in the x direction and the y direction).

However, such parallelism adjustment and optical-axis angle adjustment has problems. Specifically, in the method of visually checking the shape and the inclination of the optical axis of the emitted beam b, it is difficult to achieve an adjustment with great precision. The adjustment using the image processing with the CCD is complicated and needs an expensive apparatus for the adjustment.

Another problem conventionally arising is described. The parallelism adjustment and the optical-axis angle adjustment must be performed independently. After the completion of one of the adjustments, the other adjustment is performed. Then, the former one should be re-performed. Therefore, the adjusting process becomes very complicated.

### SUMMARY OF THE INVENTION

A technical problem of the present invention is to fix the conventional problems associated with the adjustment to an emitted light in an optical pickup as described above.

It is therefore an object of the present invention to provide an inexpensive apparatus of checking an emitted light of an optical pickup which is capable of performing concurrently a parallelism adjustment and an optical-axis angle adjustment, and of checking with high precision.

An emitted-light checking apparatus for an optical pickup according to the present invention is for checking inclination and parallelism of an optical axis of light emitted from a light source of the optical pickup. The emitted-light checking apparatus is provided with: an astigmatism-producing lens member that allows passage of the light emitted from the light source of the optical pickup therethrough; and a light receiving member that receives the light having passed through the astigmatism-producing lens member. The light receiving member includes an opto-electronic integrated circuit having a receiving surface split into a plurality of receiving areas.

In a most preferred embodiment of the emitted-light checking apparatus for the optical pickup according to the present invention, an emitted-light checking apparatus receives a laser beam which has been emitted from a light source of an optical pickup undergoing the check. Then the emitted-light checking apparatus allows the received light to pass through a cylindrical lens which is for producing astigmatism, and then to enter a light receiving device that includes an optoelectronic integrated circuit having a receiving surface split into four receiving areas arranged in upper-right, upper-left, bottom-right and bottom-left positions.

In the emitted-light checking apparatus according to the embodiment, when an optical axis of the laser beam emitted from the light source of the optical pickup subject to the check is displaced from a set position, the inclination of the optical axis of the laser beam entering the light receiving device is disagreed with the split center position of the four receiving areas of the receiving surface of the light receiving device. Accordingly, the four receiving areas of the light receiving device produce photoelectric-conversion signals different in value from each other.

Hence, by means of comparison among the photoelectric-conversion signal values supplied from the four receiving areas of the light receiving device, the inclination of the optical axis of the laser beam incident on the receiving surface of the light receiving device is detected. For this reason, while checking the detection result, the operator is enabled to perform fine adjustment on the light source of the optical pickup such that the optical axis of the laser beam falls into the set position.

Further, with the emitted-light checking apparatus for the optical pickup, when the laser beam emitted from the light source of the optical pickup subject to the check is not parallel, but is concentrated or diffused, the beam pattern of the laser beam incident on the light receiving device becomes, not a circle shape, but an oval shape extending diagonally in any direction, because of the astigmatism of the cylindrical lens.

For this reason, regarding the four photoelectric-conversion signal values respectively supplied from the four receiving areas of the light receiving device, the two signal values supplied from the two receiving areas located on each diagonal line of the receiving surface are added to calculate a subtotal. Then, percentage of each subtotal with respect of the grand total of the four signal values supplied from the four receiving areas is calculated. Thus, whether the laser beam is condensed or diffused is detected. The operator is enabled to perform fine adjustment (parallelism adjustment) on the light source of the optical pickup to make the laser beam parallel while checking the detection result.

As described hitherto, with the emitted-light checking for the optical pickup in the most preferred embodiment, it is possible to perform the parallel adjustment and the optical-axis angle adjustment in tandem with each other with a single apparatus. In addition, it is possible to perform adjustment on the optical pickup with high precision as compared with conventional adjustment involving a visual check. Still further, as compared with the conventional checking apparatus using the image processing, the present invention is able to provide a significantly inexpensive checking apparatus.

These and other objects and features of the present invention will become more apparent from the following detailed description with reference to the accompanying drawings.

### BRIEF DESCRIPTION OF THE DRAWINGS

FIG. 1 is a perspective view illustrating a typical structure of an optical pickup.

FIG. 2 is a diagram illustrating a typical method of performing a parallelism adjustment on the optical pickup.

FIG. 3 is a diagram illustrating a typical method of performing an optical-axis angle adjustment on the optical pickup.

FIG. 4 is a block diagram illustrating an embodiment according to the present invention.

FIG. 5 is a diagram illustrating the principle on which a cylindrical lens in the embodiment causes astigmatism.

FIG. 6 is a diagram illustrating laser patterns resulting from the astigmatism caused by the cylindrical lens in the embodiment.

FIG. 7 is a diagram showing the configuration of a receiving surface of a light receiving device in the embodiment.

FIG. 8 is a diagram illustrating a state in which a laser beam from the optical pickup enters the receiving surface of the light receiving device.

FIG. 9 is a diagram illustrating a state in which a condensed laser beam from the optical pickup enters the receiving surface of the light receiving device.

FIG. 10 is a diagram illustrating a state in which a diffused laser beam from the optical pickup enters the receiving surface of the light receiving device.

FIG. 11 is a diagram illustrating a state in which a parallel laser beam from the optical pickup enters the receiving surface of the light receiving device.

### DETAILED DESCRIPTION OF THE PREFERRED EMBODIMENT

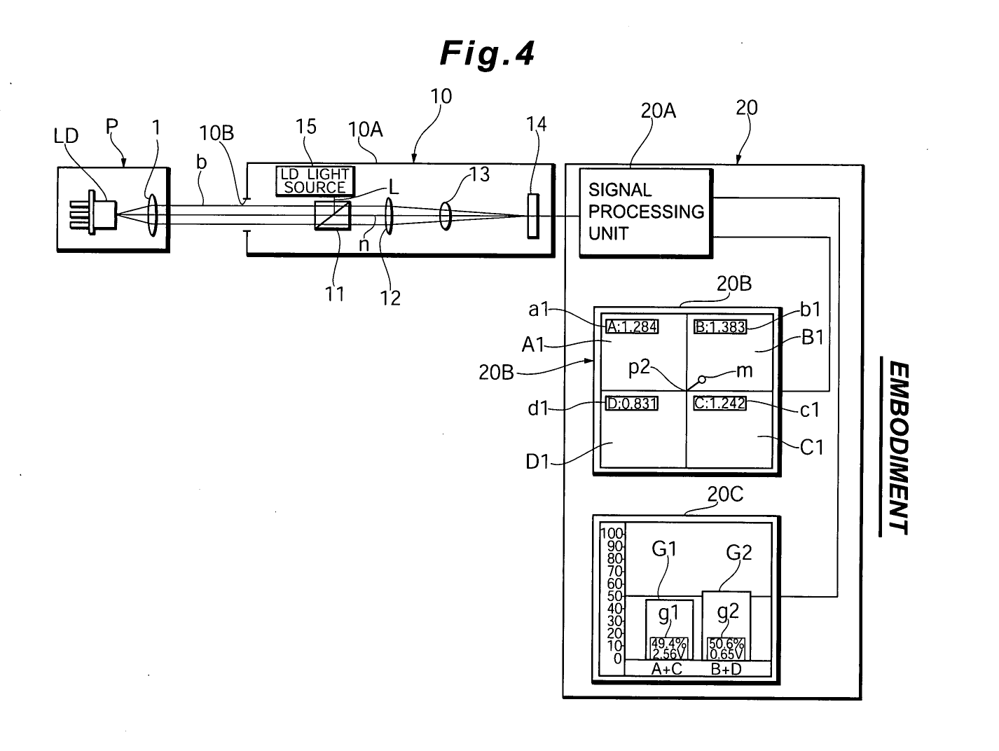

FIG. 4 shows a schematic block diagram of an embodiment of an emitted-light checking apparatus for an optical pickup according to the present invention.

In FIG. 4, an emitted-light checking apparatus 10 includes a substantially box-shaped casing 10A. A window 10B is formed in one end face (in the left end face in FIG. 4) of the casing 10A for radiating and receiving light. The casing 10A houses a beam splitter 11, a convex lens 12, a cylindrical lens 13 as described later, and a light receiving device 14 that are placed in this order from the window 10B in mutually coaxial positions along an axis n which is parallel to the axis of the casing 10A.

An LD light source 15 having a laser diode is situated opposite the beam splitter 11 inside the casing 10A, and emits a laser diode L to the beam splitter 11.

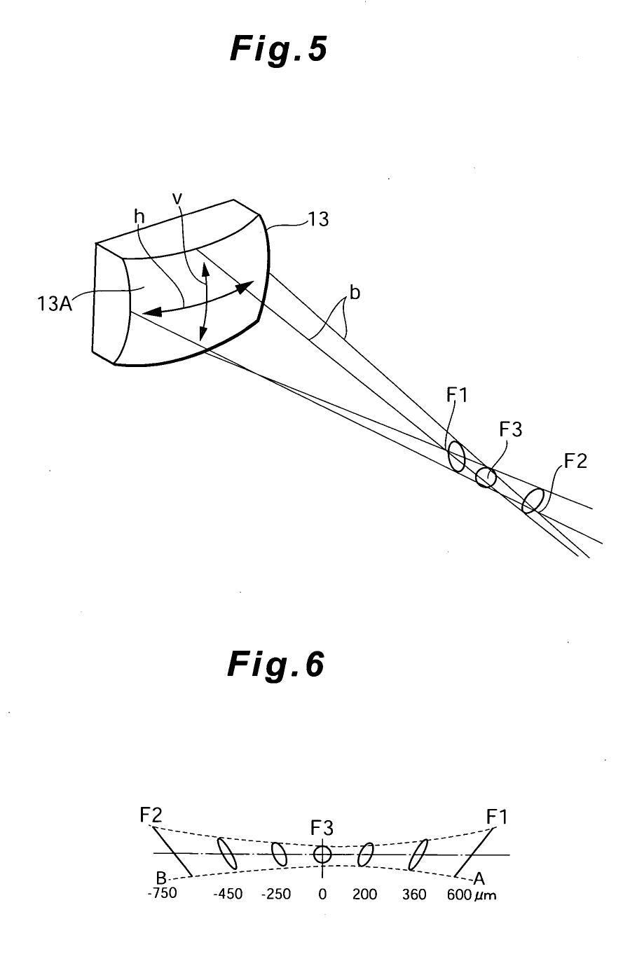

The cylindrical lens 13, as shown in FIG. 5, has a lens surface 13A of curvatures in both the horizontal h and vertical v directions, and therefore the cylindrical lens 13 has two focuses F1 and F2.

Accordingly, as shown in FIG. 6, upon the laser beam b passing through the cylindrical lens 13, the astigmatism of the cylindrical lens 13 produces different beam patterns on the laser beam b between the focus F1 close to the lens surface 13A and the focus F2 far away from the lens surface 13A. Specifically, the beam patterns becomes an oval shape extending diagonally in one direction in positions close to the focus F1, an oval shape extending diagonally in the opposite direction in positions close to the focus F2, and a perfect circle at a midpoint F3 between the focuses F1 and F2.

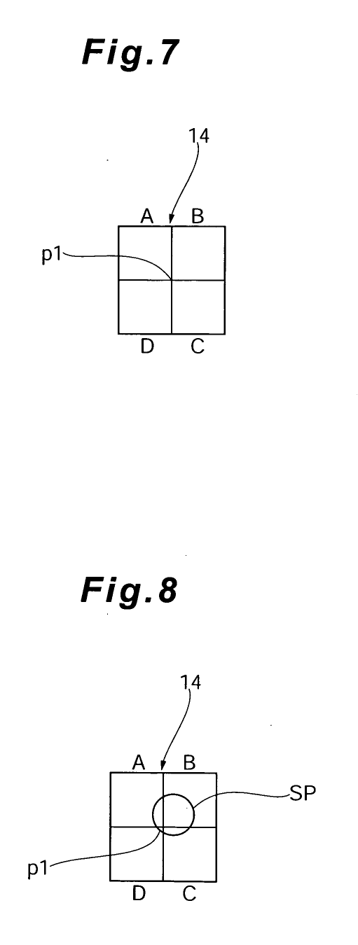

As shown in FIG. 7, the light receiving device 14 includes an OEIC (Opto-Electronic Integrated Circuit). A receiving surface of the OEIC is split into four receiving areas A, B, C and D arranged in upper-right, upper-left, bottom-right and bottom-left positions. When the laser beam b is incident on the light receiving device 14, the four receiving areas A, B, C and D produce photoelectric-conversion signals (voltage) proportional to the respective amounts of light received.

In the examples shown in FIGS. 7 to 11, the receiving surface of the light receiving device 14 is split into quarters to form the four uniform quadrate-shaped receiving areas A, B, C and D.

The light receiving device 14 is fixed in a position where the split center p1 of the receiving surface is aligned with the axis n.

The light receiving device 14 is connected to a detector (e.g. a personal computer) 20 having a signal processing unit 20A and monitors 20B and 20C. The light receiving device 14 supplies the voltages form the four receiving areas A, B, C and D to the signal processing unit 20A of the detector 20.

The signal processing unit 20 of the detector 20B stores two calculation programs. These calculations are performed on the basis of the voltage values supplied from the four receiving areas A, B, C and D of the receiving surface of the light receiving device 14. One of the programs is for calculating values of the coordinates representing inclination of the optical axis of the light incident on the light receiving device 14, when using the split center p1 of the receiving surface of the light receiving device 14 as the origin point of the coordinate system. The other is for calculating the sum of the voltage values supplied from one couple of the two diagonally positioned receiving areas, and the sum of the voltage values supplied from the other couple (i.e. a couple of the receiving areas A and C and a couple of the receiving areas B and D in FIG. 7).

Returning to FIG. 4, the monitor 20B of the detector 20 has a display screen split into four coordinates-screens of displaying areas A1, B1, C1 and D1 that are arranged in the upper-right, upper-left, bottom-right and bottom-left corresponding to the receiving areas A, B, C and D of the light receiving device 14. The monitor 20B uses a split center p2 of the coordinates-screens as the origin point, and displays the inclination of the optical axis of the laser beam b incident on the light receiving device 14, on the basis of the values of the coordinates calculated by the signal processing unit 20A.

In the example shown in FIG. 4, the displaying areas A1, B1, C1 and D1 of the monitor 20B respectively include display fields a1, b1, c1 and d1 for displaying the voltage values supplied from the corresponding receiving areas A, B, C and D of the light receiving device 14.

The monitor 20C displays graphs G1 and G2 that express as percentage a subtotal T1 and a subtotal T2 with respect to the grand total T. The grand total T is the sum of the voltage values respectively supplied from the four receiving areas A, B, C and D of the receiving surface of the light receiving device 14. The voltage subtotal T1 is the sum of the voltage values supplied from the receiving areas A and C which are located in a diagonal direction of the receiving surface. The voltage subtotal T2 is the sum of the voltage values supplied from the receiving areas B and D.

The display screen of the monitor 20C includes display fields g1 and g2 for showing, in correspondence with the graphs G1 and G2, the subtotal T1 of the voltage values of the receiving areas A and C, the subtotal T2 of the voltage values of the receiving areas B and D, and percentages of the subtotals T1 and T2 with respect to the grand total T.

Next, a description is given of a method of checking the emitted light in the optical pickup P by the use of the emitted-light checking apparatus 10.

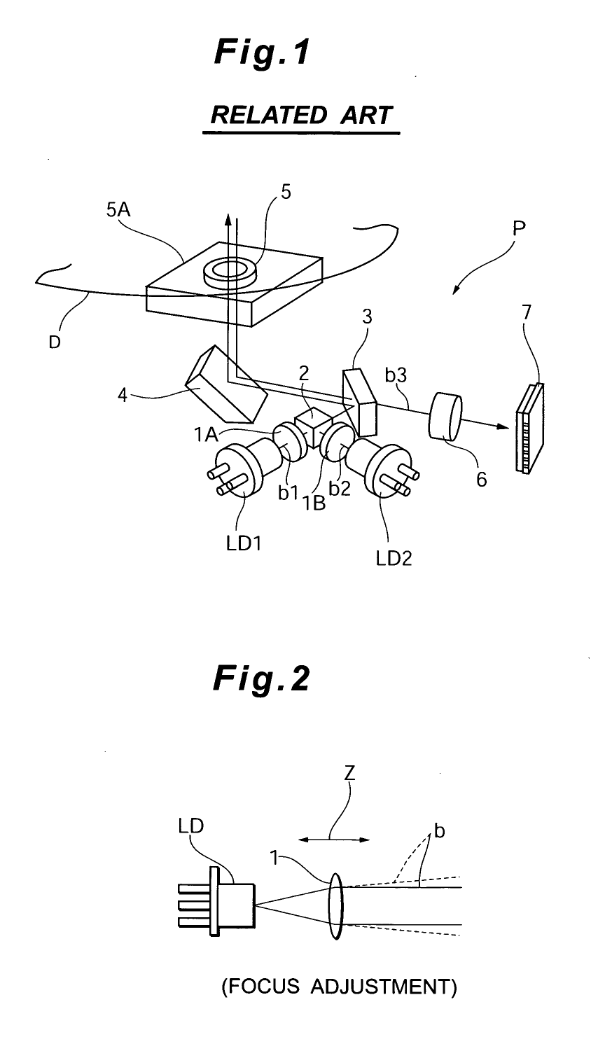

When an adjustment to light emitted from the DVD laser diode LD1/CD laser diode LD2 (i.e. the parallelism adjustment and the tracking adjustment) is performed on the optical pickup 10 shown in FIG. 1, the optical pickup 10 subject to the adjustment is placed and fixed in a position where the objective lens 5 of the pickup 10 faces the window 10B of the emitted-light checking apparatus 10.

This situation is shown in FIG. 4 with the use of a simplified structure of the optical pickup P.

In FIG. 4, a laser beam b is emitted from the laser diode LD undergoing the adjustment, then is temporarily converted into a parallel light by the auto-collimator 1, and then is received by the emitted-light checking apparatus 10.

The laser beam b travels from the window 10B into the emitted-light checking apparatus 10, and then passes through the beam splitter 11. Thereafter, the laser beam b is concentrated by the convex lens 12, then travels through the cylindrical lens 13, and then enters the light receiving device 14.

Each of FIGS. 8 to 11 shows an example of the laser beam b incident on the light receiving device 14. In each of FIGS. 8 to 11, “SP” denotes a spot region of the laser beam b on the receiving surface of the light receiving device 14.

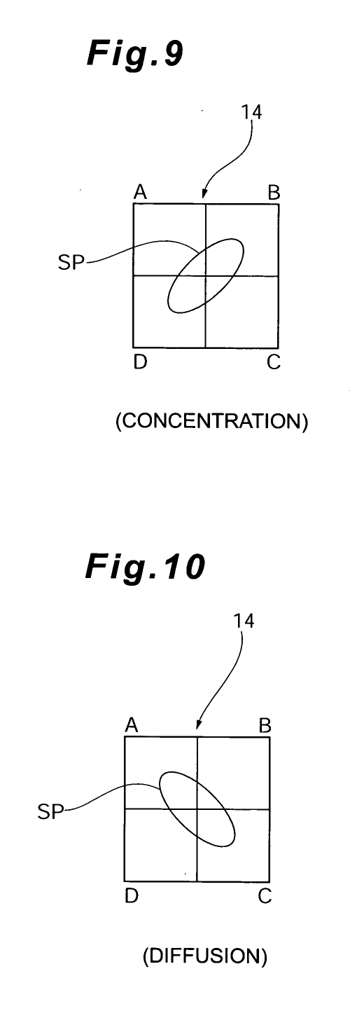

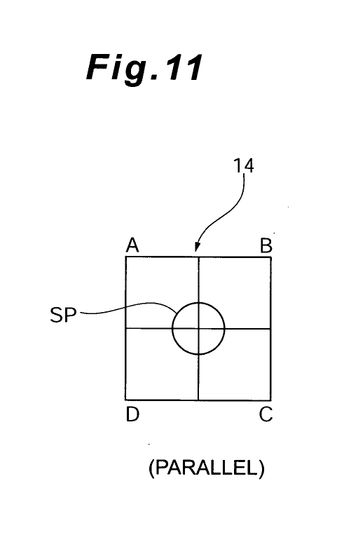

FIG. 8 illustrates the case when the optical axis of the laser beam b is misaligned (i.e. the optical-axis angle adjustment is not performed). FIG. 9 illustrates the case of the laser beam b being concentrated. FIG. 10 illustrates the case of the laser beam b being diffused. FIG. 11 illustrates the case of the laser beam b being a parallel beam (i.e. the parallelism adjustment is made).

Note that FIG. 8 shows the state in which the optical pickup P has been adjusted for parallelism and the spot region SP is in a circle shape. In actuality, the spot region SP may be often in an oval shape extending diagonally in any direction, as shown in FIG. 9 or 10, before the parallelism adjustment is performed on the optical pickup 10.

First, the optical-axis angle adjustment is described with reference to FIG. 8. In the example in FIG. 8, the inclination of the optical axis of the laser beam b is shifted from the split center p1 of the light receiving device 14 toward the receiving area B. Therefore, the receiving area B among the four receiving areas A, B, C and D has the largest area overlapping the spot region SP of the laser beam b.

Hence, the receiving area B of the light receiving device 14 supplies the largest voltage value to the signal processing unit 20A of the detector 20, and the other receiving areas A, C and D supplies voltage values proportional to the respective areas overlapping the spot region SP.

Based on the voltage values supplied from the receiving areas A, B, C and D of the light receiving device 14, the signal processing unit 20A of the detector 20 compares magnitudes of the voltage values and calculates inclination of the optical axis from the center point of the spot region SP on the receiving surface of the light receiving device 14, that is, from the coordinates-position of the laser beam b.

The signal processing unit 20A supplies to the monitor 20B data indicating the calculated coordinates-position of the optical axis of the laser beam b. Thus the monitor 20B displays a spot mark m, indicating the inclination of the optical axis of the laser beam b, on the coordinates-screens having the split center p2 serving as the origin point formed on the screen of the monitor 20B.

Further the signal processing unit 20A supplies to the monitor 20B data indicating the voltage values of the receiving areas A, B, C and D sent from the light receiving device 14, without any change. Thereby, the monitor 20B displays the voltage values in the corresponding display fields a1, b1, c1 and d1 in the displaying areas A1, B1, C1 and D1.

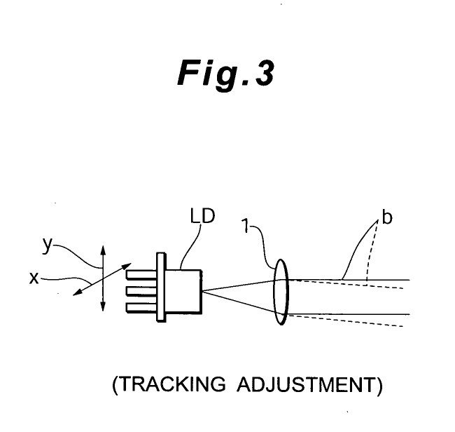

For the optical-axis angle adjustment, while the operator is checking the position of the spot mark m displayed on the coordinates-screen of the monitor 20B, the operator makes fine adjustment of an angle and a position of the laser diode LD in two directions at right angles to the optical axis of the emitted beam b as shown in FIG. 3, so as to align the spot mark m with the split center p2 of the coordinates-screens.

Next, the method of performing the parallelism adjustment is described with FIGS. 9 to 11.

The signal processing unit 20A of the detector 20 evaluates a grand total T of the voltage values respectively supplied from the four receiving areas A, B, C and D of the light receiving device 14, a subtotal T1 of the voltage values supplied from the receiving areas A and C which are arranged on a diagonal line, and a subtotal T2 of the voltage values supplied from the receiving areas B and D which are arranged on another diagonal line. Then, the signal processing unit 20A evaluates percentages of the voltage subtotals T1 and T2 with respect to the grand total T, and then supplies data indicative of the evaluated result to the monitor 20C.

The monitor 20C displays graphs G1 and G2 showing the percentages of the subtotals T1 and T2 with respect to the grand total T on the basis of the data supplied from the signal processing unit 20A.

Further, the monitor 20C displays, in addition to the graphs G1 and G2, values indicative of the subtotals T1 and T2 and the percentages of the subtotals T1 and T2 with respect to the grand total T in the corresponding display fields g1, g2 on the display screen.

More specifically, in the state in which the laser beam b is concentrated as shown in FIG. 9, the subtotal T1 of the voltage values of the receiving areas A and C is a smaller percentage than the subtotal T2 of the voltage values of the receiving areas B and D. Therefore, the graph G1 displayed is smaller than the graph G2 (corresponding to the case shown in FIG. 4). However, in the state in which the laser beam b is diffused as shown in FIG. 10, the subtotal T1 is a larger percentage than the subtotal T2, and therefore, the graph G1 displayed is larger than the graph G2. Further, in the state in which the laser beam b is parallel as shown in FIG. 11 (i.e. in the focused state), both the percentages of the subtotal T1 and the subtotal T2 becomes equally 50 percent, and the displayed graphs G1 and G2 are equal in size.

For the parallelism adjustment, while the operator is checking the sizes of the graphs G1 and G2 displayed on the screen of the monitor 20C, the operator performs fine adjustment of a position of the collimator lens 1 in the axis direction as shown in FIG. 2.

As described hitherto, in the emitted-light checking apparatus 10 according to the present invention, a laser beam b, which has been emitted from the laser diode LD of the optical pickup P subject to the adjustment, travels through the cylindrical lens 13, and then enters into the light receiving device 14 that includes the OEIC (Opto-Electronic Integrated Circuit) split into four parts. Then, based on photoelectric-conversion signals (voltage) supplied from the receiving areas A, B, C and D of the light receiving device 14, the inclination of the optical axis of the laser beam b is displayed on the monitor 20B, and also the parallelism of the laser beam b is displayed on the monitor 20C, which then enables the operator to make the parallel adjustment and the optical-axis angle adjustment in tandem with each other while watching the screens of the monitors 20B and 20C. As a result, it is possible to facilitate performing the emitted-light adjustment to the optical pickup P as compared with the conventional adjustment.

Further, as compared with the conventional emitted-light adjustment involving a visual check, the emitted-light checking apparatus 10 is capable of significantly enhancing the adjustment precision. Still further, as compared with the conventional apparatus using the image processing to check the emitted light, the present invention is able to provide the adjustment apparatus at low costs.

In the aforementioned embodiment, the emitted-light checking apparatus 10 has the beam splitter 11 and the LD light source 15. Accordingly, the emitted-light checking apparatus 10 can be used as a tilt sensor for detecting a tilt of a measured object and the like. In this case, a laser beam L is emitted from the LD light source 15 and reflected by the beam splitter 11 to be incident on the measured object. Then, the emitted-light checking apparatus 10 receives the light reflected from the measured object and thereby detects the tilt or the like.

The terms and description used herein are set forth by way of illustration only and are not meant as limitations. Those skilled in the art will recognize that numerous variations are possible within the spirit and scope of the invention as defined in the following claims.

1. An emitted-light checking apparatus for an optical pickup in which inclination and parallelism of an optical axis of light emitted from a light source of the optical pickup is checked, comprising:
an astigmatism-producing lens member that receives the light emitted from the light source of the optical pickup and allows the light to pass therethrough; and
a light receiving member that receives the light having passed through the astigmatism-producing lens member, and includes an opto-electronic integrated circuit having a receiving surface split into a plurality of receiving areas.

2. An emitted-light checking apparatus for an optical pickup according to claim 1,
wherein the receiving surface of the optoelectronic integrated circuit included in the light receiving member is split into four areas arranged in upper-right, upper-left, bottom-right and bottom-left positions.

3. An emitted-light checking apparatus for an optical pickup according to claim 1, further comprising
a signal processing member that is connected to the light receiving member and receives input of signals respectively proportional to amounts of light received by the receiving areas from the receiving areas of the receiving surface of the light receiving member, the signal processing member adding values of the signals supplied from the receiving areas located on each of diagonal lines of the receiving surface together to calculate a subtotal, and then calculating a percentage of each of the subtotals with respect of the a grand total of the values of the signals supplied from all the receiving areas.

4. An emitted-light checking apparatus for an optical pickup according to claim 3,
wherein the signal processing member further calculates values of coordinates of the light incident on the receiving surface of the light receiving member on the basis of the signal supplied from each of the receiving areas of the light receiving member, to detect inclination of the optical axis.

5. An emitted-light checking apparatus for an optical pickup according to claim 3,
wherein the signal supplied from each of the receiving areas of the light receiving member to the signal processing member is a voltage proportional to the amount of light received by each receiving area.

6. An emitted-light checking apparatus for an optical pickup according to claim 3,
further comprising a first monitor member that is connected to the signal processing member,
wherein the signal processing member supplies, to the first monitor member, data indicating the percentage of each subtotal which is obtained by adding together the values of the signals supplied from the receiving areas located on each diagonal line of the receiving surface of the light receiving member with respect to the grand total, to allow the first monitor member to display the percentage.

7. An emitted-light checking apparatus for an optical pickup according to claim 3, wherein the signal processing member allows the first monitor member to display the percentage of each subtotal which is obtained by adding together the values of the signals supplied from the receiving areas located on each diagonal line of the receiving surface of the light receiving member with respect to the grand total as shown on a graph.

8. An emitted-light checking apparatus for an optical pickup according to claim 3, wherein the signal processing member allows the first monitor member to display the percentage of each subtotal which is obtained by adding together the values of the signals supplied from the receiving areas located on each diagonal line of the receiving surface of the light receiving member with respect to the grand total as shown by numeric values.

9. An emitted-light checking apparatus for an optical pickup according to claim 4,
further comprising a second monitor member connected to the signal processing member,
wherein the signal processing member allows the second monitor member to display the inclination of the optical axis of the light entering the light receiving member on the basis of the calculated values of the coordinates.

10. An emitted-light checking apparatus according to claim 9, wherein
the second monitor member has a display screen that is split in correspondence with the receiving areas of the receiving surface of the light receiving member to form coordinates-screens,
a spot mark indicating the inclination of the optical axis of the light incident on the receiving surface is displayed on the coordinates-screens.

11. An emitted-light checking apparatus for an optical pickup according to claim 9, wherein the second monitor member displays the value of the signal supplied from each of the receiving areas of the light receiving member.
